(19) United States
(12) Patent Application Publication
(10) Pub. No.: US 2006/0202583 A1
(43) Pub. Date: Sep. 14, 2006

(54) Power consumption apparatus making use of vector quantity

(76) Inventor: Shinichirou Takeuchi, Kobeshi (JP)

Correspondence Address: TAKEUCHI&KUBOTERA,LLP;SUITE 202, 200 DAINGERFIELD ROAD, ALEXANDRIA, VA, 22314, US

(21) Appl. No.: 11/371,053

(22) Filed: Mar. 9, 2006

(30) Foreign Application Priority Data
Mar. 13, 2005 (JP) 2005-113855

(51) Int. Cl. H02K 19/20; H02K 21/00

(52) U.S. Cl. 310/168; 310/181

(57) ABSTRACT

A power consumption apparatus becomes independent of induced counter electromotive forces. The power consumption apparatus (100) includes a magnetic core (10) forming a static closed circuit; a couple of permanent magnets (20) in close contact with the magnetic core (10) such that two dynamic magnetic circuits (40) are formed through the magnetic core (10); coils (60) each wound around portions (50) including the dynamic magnetic circuits (40) so as to make the mutual inductance negative; and a device (14) for making the dynamic magnetic circuits (40) dynamic so that the induced currents (500) run through the coils (60) to prevent each other's counter electromotive force from inducing.

### CROSS-REFERENCE TO RELATED APPLICATIONS

The present application claims the benefit of patent application number, 2005-113,855 filed in Japan on Mar. 13, 2005, the subject matter of which is hereby incorporated by reference.

### BACKGROUND OF THE INVENTION

1. Field of the Invention

The present invention relates to an electrical power apparatus in which a transformer electromotive force is induced.

2. Description of the Related Art

According to Ampere's law, an electric current produces a magnetic field. An electric current put in a magnetic field produces an Ampere force. According to Faraday's law of induction on putting a coil in a magnetic field from a permanent magnet and joining an ammeter at the coil end, when the permanent magnet is moved by a force, an electric current flows because the magnetic field varies. These are relations among an electric current, a magnetic field, and a force. An example of the application thereof is a generator or transformer.

The induced current in a generator runs in the direction to counter the change of an original magnetic field so that a repulsive force acts between the magnetic filed produced by the induced current and the magnetic field produced by the original permanent magnet. Consequently, it is necessary to continue applying externally a torque to keep the coil to rotate. The same for a transformer is accepted because a generator is used on the primary side of a transformer.

As a result, it is believed that the electrical work is equal to the mechanical work applied to the generator externally. This belief results from the technical idea that the apparent vector quantity is subordinate to the real vector quantity.

U.S. Pat. No. 4,260,914 discloses a differential linear velocity transducer which comprises a fixed permanent magnet, iron pole pieces, and two oppositely wound coils so that signals are added up while noises are cancelled out. For the electric power produced by sliding the coils, it becomes inefficient.

U.S. Pat. No. 6,245,561 discloses a device for controlling the path of a magnetic flux from a permanent magnet, which is useful for power transformation. In this device that the magnetic flux is changed by moving the armature making the magnetic path, a large amount of flux leaks and does not interlink with the coil.

### SUMMARY OF THE INVENTION

Accordingly, it is an object of the invention to provide an electric power consumption apparatus or method of optimizing the influence of a magnetic field of induced current to prevent the counter electromotive force from being induced in a power coil in which transformer electromotive forces are induced.

According to the invention there is provided a power consumption apparatus which includes a magnetic core forming a static closed magnetic circuit; a permanent magnet, an end of which is in close contact with the magnetic core such that a branched dynamic magnetic circuit is formed through the magnetic core branched out into by a magnetic flux from the permanent magnet; coils each wound around portions of the magnetic core including at least one magnetic flux so as to make mutual inductances negative; and a device for making the dynamic magnetic circuit dynamic such that an operating point of the permanent magnet is reciprocated on a minor loop of the permanent magnet so that at least one current runs through the coils to prevent each other's counter electromotive force from being produced in the power coils.

According to another aspect of the invention there is provided a method of consuming an electric power which comprises the steps of bringing a permanent magnet into close contact with a magnetic core to provide a first magnetic flux that branches out to form a dynamic magnetic circuit through the interposed magnetic core; winding a power coil around a portion of the magnetic core of the dynamic magnetic circuits; making the dynamic magnetic circuit dynamic to change the first magnetic flux passing through the power coil such that an operating point of the permanent magnet is reciprocated on a minor loop of the permanent magnet, inducing a transformer electromotive force in the power coil so that the coil catches a negative mutual inductance from a coil; and inducing a second magnetic flux that magnetic fields of induced currents in each coil is substantially equal in magnitude but opposite in direction to each other to thereby prevent substantially a counter electromotive force induced in the each coil.

Since a negative mutual inductance acts in a power coil due to the plurality of magnetic fluxes from an induced current and the fact that the sum of two vector quantities of equal magnitudes in opposite directions becomes zero is applied to the magnetic fluxes of the induced current, it is possible to prevent substantially the counter electromotive force induced in the power coil by means of only the magnetic energy of the induced current itself.

### BRIEF DESCRIPTION OF THE DRAWINGS

FIG. 1 is a schematic view of an electric power consumption apparatus according to an embodiment of the invention;

FIG. 2 is a schematic view of an electric power consumption apparatus with a small magnetic flux leak for a large electric current according to a second embodiment of the invention; and

FIG. 3 is a schematic view of an electric power consumption apparatus with reduced cogging between the permanent magnet and the magnetic core according to a third embodiment of the invention.

### DESCRIPTION OF THE PREFERRED EMBODIMENTS

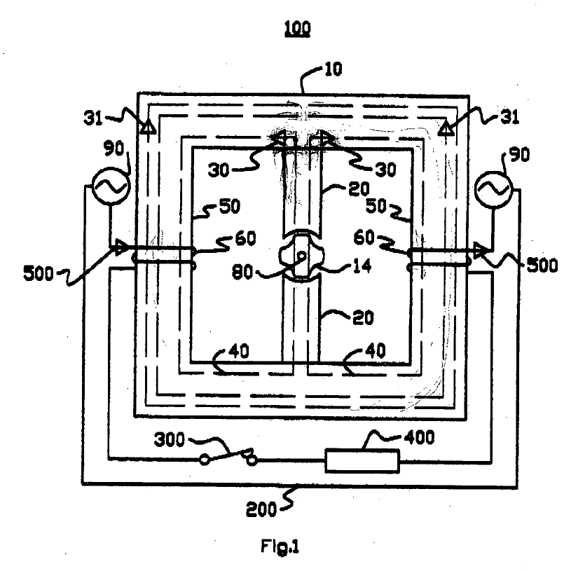

In FIG. 1, a power consuming device 100 comprises a first magnetic core member 10 forming a static closed path, a couple of permanent magnets 20, an end of which is in close contact with the first magnetic core member 10 so that dynamic magnetic circuits 40 are formed through the magnetic core member 10 interposed in a natural flux-loop of the permanent magnets 20 by a first magnetic flux 30, a couple of power coils 60 electromagnetically coupled on portions 50 of the magnetic core member 10 shared the first magnetic fluxes 30 with equal inductance, a second magnetic core 14 with such a configuration, when it is rotated, as to make the dynamic magnetic circuit 40 dynamic such that an operating point of the permanent magnets 20 is reciprocated on a minor loop of the permanent magnets 20, and a shaft member 80 supported rotatably and fitted in the second magnetic core 14 to transmit an external torque to the second magnetic core 14.

The electric power consumption device is FIG. 1 functions as follows. When a certain torque is continuously applied to the shaft member 80 to rotate the second magnetic core 14, the first fluxes 30 are changed regularly. Consequently, an emf 90 is produced in each power coil 60 in such a direction as to prevent the change of the first magnetic flux 30. Each first magnetic flux 30 runs through each power coil 60 in the opposite direction so that the emf 90 is produced in the opposite direction, making the mutual inductance of each power coil 60 negative. Preferably, the power coils 60 are joined to themselves.

When the power coils 60 are connected to each other through a switch 300 and a load 400 to conduct an induced current 500, forming second fluxes 31 of equal magnitudes in opposite directions. Since the mutual inductance is negative, the counter emfs by the induced current 500 are almost prevented by the mutual inductance of the magnetic fluxes 31. In other words, the coils prevent each other's counter electromotive forces from inducing in the coils.

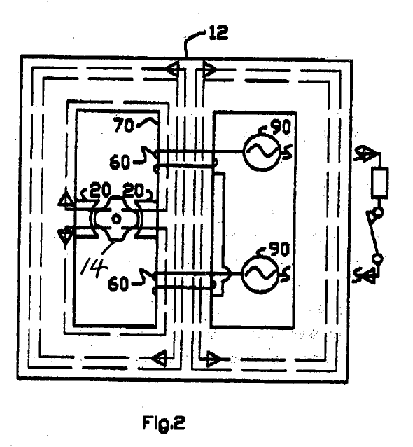

In FIG. 2, an improvement is made so as to reduce the leakage flux of the induced current 500. The magnetic core 10 is replaced with a magnetic core 12 having a central leg 70. A couple of permanent magnets 20 are provided between and in close contact with the central leg 70 and a left side leg of the magnetic core 12. A couple of power coils 60 are provided around the central leg 70 across the right side permanent magnet 20. They are preferably connected such that the emfs 90 are added up. Since the power coils 60 are provided on the central leg 70, the leakage flux from the coils is reduced to a negligible amount.

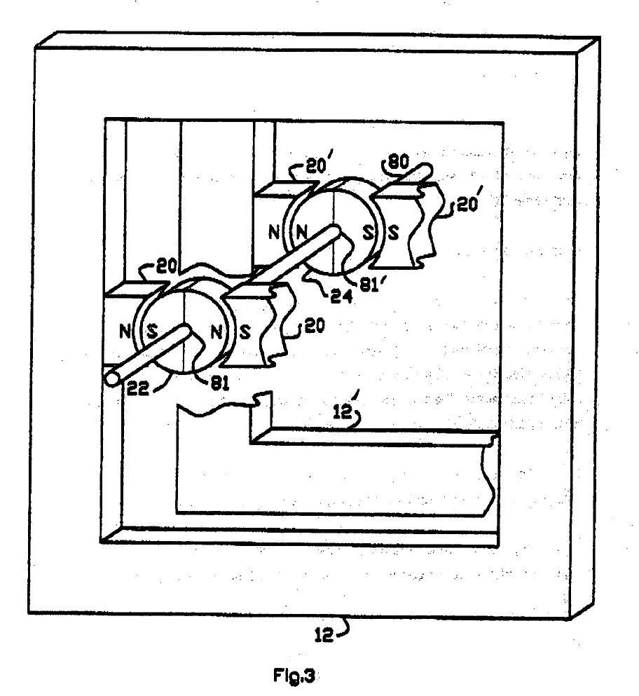

In FIG. 3, an improvement is made to reduce the cogging between a rotated magnetic core and a permanent magnet. Two sets of the FIG. 2 devices are provided. The magnetic core 14 is replaced with a pair of permanent magnets 22 and 24. The second permanent magnet 22 has a fit-portion 81 through which the shaft 80 is fitted and is rotated with an attractive force between the first permanent magnet 20 and the second permanent magnet 22 in the magnetic field of the first permanent magnet 20 that is in close contact with the magnetic core 12 of the first set while the fourth permanent magnet 24 has a fit-portion 81′ through which the shaft 80 is fitted and is rotated with a repulsive force between the third magnet 20′ and the fourth magnet 24 in the magnetic field of the third magnet 20′ that is in close contact with the second magnet core 12′ of the second set.

As the permanent magnets 22 and 24 rotate, the attractive force becomes a repulsive force while the repulsive force becomes an attractive force so that the shaft 80 always receives torques in the opposite directions caused by the attractive and repulsive forces. Consequently, the cogging is reduced.

Alternatively, to transfer torque from external an embodiment of the invention may modified through at least one driver member added to that shaft. The illustrated examples are explicative only and not limitative to the scope of the invention.

1. A power device comprising a transformer electromotive force induced and/or a counter electromotive force induced, characterized by a transformer electromotive force induced in a power coil wound around a magnetic core by reciprocating an operating point of a permanent magnet on a minor loop of said permanent magnet having an end of which is in close contact with said static closed magnetic core, a prevented substantially counter electromotive force induced in said power coil by catching negative mutual inductance and means of only a magnetic energy of a induced current itself.

2. A power consumption device comprising:
a magnetic core forming a static closed magnetic circuit;
a permanent magnet, an end of which is in close contact with said magnetic core such that a dynamic magnetic circuit is formed through said magnetic core branched out into by a magnetic flux from said permanent magnet;
coils each wound around portions of said magnetic core including said magnetic flux so as to make mutual inductances negative; and
means for making said dynamic magnetic circuit dynamic such that an operating point of said permanent magnet is reciprocated on a minor loop of said permanent magnet so that a current runs through said coils to prevent a counter electromotive force from inducing.

3. A method of consuming an electric power comprising the steps of:
reciprocating an operating point of a permanent magnet on a minor loop of the permanent magnet in a dynamic magnetic circuit so that a first magnetic flux from the permanent magnet having an end of which is in close contact with static closed magnetic core varies in a power coil wound around a portion of said magnetic core of said dynamic magnetic circuit formed through said magnetic core interposed in said first magnetic flux;
inducing a transformer electromotive force in said power coil such that said power coil is coupled electromagnetically negatively; and
inducing a second magnetic flux that a magnetic field of said induced current in said power coil is substantially equal in magnitude but opposite in directions to each other to thereby prevent substantially a counter electromotive force induced in said power coil.
